(19) United States
(12) Patent Application Publication
(10) Pub. No.: US 2026/0049645 A1
(43) Pub. Date: Feb. 19, 2026

(54) SHOCK ABSORBER

(71) Applicant: KYB Corporation, Tokyo (JP)

(72) Inventors: Hiroaki ITOGAWA, Tokyo (JP); Kazutaka INAMITSU, Tokyo (JP)

(73) Assignee: KYB Corporation, Tokyo (JP)

(21) Appl. No.: 19/102,420

(22) PCT Filed: Aug. 8, 2023
(86) PCT No.: PCT/JP2023/028848

§ 371 Date: Feb. 10, 2025

(30) Foreign Application Priority Data
Dec. 9, 2022 (JP) 2022-196705

(51) Int. Cl. F16F 9/06; F16F 9/50

(52) U.S. Cl. CPC F16F 9/062; F16F 9/065; F16F 9/50; F16F 2222/12; F16F 2228/066; F16F 2232/08; F16F 2234/02

(57) ABSTRACT

A shock absorber (D) of the present invention includes: a cylinder (1); a piston (2) that is movably inserted into the cylinder (1) and partitions an inside of the cylinder (1) into an extension side chamber (R1) and a compression side chamber (R2) filled with a liquid; a piston rod (3) that is inserted into the cylinder (1) and connected to the piston (2); an outer tube (4) that is disposed on an outer peripheral side of the cylinder (1) and forms a liquid storage chamber (R3) filled only with a liquid inside; a damping passage (P) that allows communication between the extension side chamber (R1) and the liquid storage chamber (R3); a variable damping valve (V) that is provided in the damping passage (P) and capable of adjusting resistance applied to a flow of a liquid from the extension side chamber (R1) to the liquid storage chamber (R3); and a tank (6) that is disposed outside the outer tube (4) and communicates with the liquid storage chamber (R3) to store a liquid.

### TECHNICAL FIELD

The present invention relates to a shock absorber.

### BACKGROUND ART

Some shock absorbers that exert a damping force for suppressing vibration can adjust the damping force. As such a shock absorber, for example, a shock absorber capable of adjusting a damping force by using a solenoid valve using a solenoid as a damping valve is well known. Here, in a case where the damping force adjustment can be performed at both the time of extension operation and the time of contraction operation, when both a damping valve that exerts a damping force at the time of extension operation and a damping valve that exerts a damping force at the time of contraction operation are provided, the cost becomes high.

Therefore, a shock absorber has been developed that employs a structure in which a damping passage through which hydraulic oil passes even when the shock absorber extends or contracts is provided, a damping valve is installed in the damping passage, and the damping force adjustment can be performed at both the time of extension operation and the time of contraction operation.

Specifically, for example, as disclosed in JP 2014-231912 A, the shock absorber includes: a cylinder; a piston slidably inserted into the cylinder; a piston rod that is movably inserted into the cylinder and connected to the piston; a rod-side chamber and a piston-side chamber partitioned by the piston inserted into the cylinder; an intermediate tube that covers an outer periphery of the cylinder and forms a damping passage between the cylinder and the intermediate tube; an outer tube that covers an outer periphery of the intermediate tube and forms a reservoir between the intermediate tube and the outer tube; a suction passage that allows only a flow of hydraulic oil from the reservoir toward the piston-side chamber; a piston passage that is provided in the piston and allows only a flow of hydraulic oil from the piston-side chamber toward the rod-side chamber; and a damping valve that is provided between the damping passage and the reservoir.

### CITATION LIST

### Patent Literature

Patent Literature 1: JP 2014-231912 A

### SUMMARY OF INVENTION

### Technical Problem

In the conventional shock absorber configured as described above, when the hydraulic oil that has passed through the damping valve forms a jet and vigorously flows into the reservoir, the jet stirs the hydraulic oil in the reservoir facing gas, and the gas is entrained in and mixed with the hydraulic oil in the reservoir, a waveform (damping waveform) of a damping force generated with respect to displacement of the shock absorber is disturbed, and it is difficult to exert an intended damping force.

Therefore, in the conventional shock absorber, it is necessary to increase an amount of oil in the reservoir to keep an oil level in the reservoir as far away from a liquid outlet of the damping valve as possible, and thus an axial length of the outer tube forming the reservoir becomes long and a basic length of the shock absorber becomes long. When the basic length of the shock absorber becomes long as described above, mountability of the shock absorber on an installation target deteriorates.

Therefore, an object of the present invention is to provide a shock absorber capable of exerting a desired damping force without impairing mountability on an installation target.

### Solution to Problem

In order to achieve the above object, a shock absorber of the present invention includes: a cylinder; a piston that is movably inserted into the cylinder and partitions an inside of the cylinder into an extension side chamber and a compression side chamber filled with a liquid; a piston rod that is inserted into the cylinder and connected to the piston; an outer tube that is disposed on an outer peripheral side of the cylinder and forms a liquid storage chamber filled only with a liquid inside; a damping passage that allows communication between the extension side chamber and the liquid storage chamber; a variable damping valve that is provided in the damping passage and capable of adjusting resistance applied to a flow of a liquid from the extension side chamber to the liquid storage chamber; and a tank that is disposed outside the outer tube and communicates with the liquid storage chamber to store a liquid.

In the shock absorber configured as described above, since the tank is provided outside the outer tube, the liquid storage chamber can be filled only with the liquid, and even when the liquid flows into the liquid storage chamber through the variable damping valve during the extension/contraction operation, it is possible to prevent a liquid from entraining gas in the liquid storage chamber.

### BRIEF DESCRIPTION OF DRAWINGS

FIG. 1 is a cross-sectional view of a shock absorber according to one embodiment.

FIG. 2 is a diagram of damping force characteristics of the shock absorber according to the embodiment.

FIG. 3 is a cross-sectional view of a shock absorber according to a modification of the embodiment.

### DESCRIPTION OF EMBODIMENTS

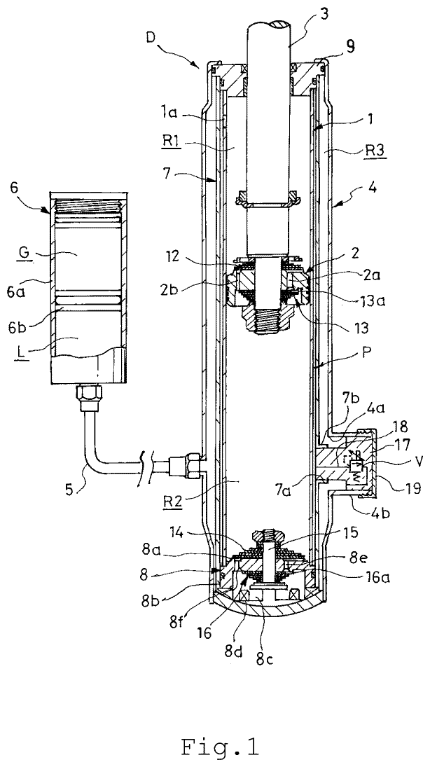

Hereinafter, a shock absorber D according to the present invention will be described with reference to the drawings. As shown in FIG. 1, the shock absorber D according to one embodiment includes: a cylinder 1; a piston 2 that is movably inserted into the cylinder 1 and partitions an inside of the cylinder 1 into an extension side chamber R1 and a compression side chamber R2 filled with a liquid; a piston rod 3 that is inserted into the cylinder 1 and connected to the piston 2; an outer tube 4 that is disposed on an outer peripheral side of the cylinder 1 and forms a liquid storage chamber R3 filled only with a liquid inside; a damping passage P that allows communication between the extension side chamber R1 and the liquid storage chamber R3; a variable damping valve V that is provided in the damping passage P and capable of adjusting resistance applied to a flow of a liquid from the extension side chamber R1 toward the liquid storage chamber R3; and a tank 6 that is disposed outside the outer tube 4 and communicates with the liquid storage chamber R3 to store a liquid.

Each unit of the shock absorber D will be described in detail below. The cylinder 1 has a tubular shape, and the piston 2 is movably inserted into an inside of the cylinder 1 as described above, and the extension side chamber R1 is partitioned on an upper side of the piston 2 in FIG. 1, and the compression side chamber R2 is partitioned on a lower side of the piston 2 in FIG. 1. Each of the extension side chamber R1 and the compression side chamber R2 is filled with a liquid, more specifically, hydraulic oil, for example. Instead of the hydraulic oil, each of the extension side chamber R1 and the compression side chamber R2 may also be filled with water or an aqueous solution, for example, as a liquid.

The cylinder 1 is accommodated in the outer tube 4 having a bottomed tubular shape and disposed on an outer peripheral side thereof. An intermediate tube 7 is inserted between the cylinder 1 and the outer tube 4, a damping passage P is formed by an annular gap between the cylinder 1 and the intermediate tube 7, and a liquid storage chamber R3 is formed by an annular gap between the intermediate tube 7 and the outer tube 4. In the vicinity of an upper end of the cylinder 1, a hole 1a that allows communication between the extension side chamber R1 and the damping passage P is provided. Furthermore, the outer tube 4 covers an outer periphery of the cylinder 1 over the entire length of the cylinder 1, and accommodates the entire cylinder 1 therein. The damping passage P and the liquid storage chamber R3 are filled with hydraulic oil similarly to the cylinder 1.

A valve case 8 is fitted to lower ends of the cylinder 1 and the intermediate tube 7 in FIG. 1, and a rod guide 9 that slidably and axially supports the piston rod 3 is fitted to upper ends of the cylinder 1 and the intermediate tube 7 in FIG. 1. The cylinder 1 and the intermediate tube 7 are sandwiched between the valve case 8 and the rod guide 9 and positioned so as to be concentric in a radial direction. Both the lower end of the cylinder 1 and the lower end of the intermediate tube 7 are closed by the valve case 8, and the compression side chamber R2 in the cylinder 1 and the liquid storage chamber R3 outside the cylinder 1 and formed in the outer tube 4 are partitioned by the valve case 8.

In this manner, the valve case 8 and the rod guide 9 sandwiching the cylinder 1 and the intermediate tube 7 are inserted into an inner periphery of the outer tube 4. When an upper end of the outer tube 4 is caulked, the cylinder 1, the intermediate tube 7, the valve case 8, and the rod guide 9 are sandwiched between the caulked portion and the bottom portion of the outer tube 4, and are fixed in the outer tube 4. A seal member (not shown) seals between the rod guide 9 and the piston rod 3 and between the rod guide 9 and the outer tube 4 to prevent leakage of the liquid from the inside of the shock absorber D. Instead of caulking an upper end opening end of the outer tube 4, a cap may be screwed to an upper end opening edge of the outer tube 4, and the rod guide 9, the cylinder 1, the intermediate tube 7, and the valve case 8 may be sandwiched between the cap and the bottom portion of the outer tube 4, thereby fixing these members in the outer tube 4.

The piston 2 has an annular shape and is connected to the piston rod 3, and includes an extension side port 2a that partitions the inside of the cylinder 1 into an extension side chamber R1 in the upper part of FIG. 1 and a compression side chamber R2 in the lower part of FIG. 1 and allows communication between the extension side chamber R1 and the compression side chamber R2, and a compression side port 2b that allows communication between the compression side chamber R2 and the extension side chamber R1.

A compression side check valve 12 formed by stacking a plurality of annular plates is provided on the extension side chamber side, which is an upper side of the piston 2 in FIG. 1. In the compression side check valve 12, an inner periphery thereof is fixed to an outer periphery of the piston rod 3, and deflection on the outer peripheral side is allowed. When a pressure of the compression side chamber R2 becomes higher than a pressure of the extension side chamber R1 and the compression side check valve 12 is deflected by receiving the pressure of the compression side chamber R2 acting via the compression side port 2b, the compression side check valve 12 opens the compression side port 2b to allow communication between the compression side chamber R2 and the extension side chamber R1, thereby allowing the flow of the hydraulic oil from the compression side chamber R2 toward the extension side chamber R1.

On the other hand, when the pressure of the extension side chamber R1 is higher than the pressure of the compression side chamber R2, the compression side check valve 12 is pressed by the pressure of the extension side chamber R1 acting from a back side to close the compression side port 2b, thereby blocking the communication between the compression side chamber R2 and the extension side chamber R1. The compression side check valve 12 may apply resistance to the flow of the hydraulic oil passing in a state where the compression side port 2b is opened to such an extent that the pressure in the extension side chamber R1 does not become negative.

On the other hand, an extension side damping valve 13 formed by stacking a plurality of annular plates is provided on the compression side chamber side, which is the lower side of the piston 2 in FIG. 1. In the extension side damping valve 13, an inner periphery thereof is fixed to the outer periphery of the piston rod 3, deflection on the outer peripheral side is allowed, and initial deflection is applied. An orifice 13a formed by a notch is provided on the outer periphery of the annular plate of the extension side damping valve 13, the annular plate being seated on and separated from the piston 2. The extension side damping valve 13 maintains the state of being seated on the piston 2 until a difference between the pressure of the extension side chamber R1 and the pressure of the compression side chamber R2 reaches a valve opening pressure set by the initial deflection even when the pressure of the extension side chamber R1 becomes higher than the pressure of the compression side chamber R2. Therefore, in this state, the hydraulic oil moves from the extension side chamber R1 to the compression side chamber R2 only via the orifice 13a, and the orifice 13a applies resistance to the flow of the hydraulic oil. When the pressure of the extension side chamber R1 becomes higher than the pressure of the compression side chamber R2, and the difference between the pressure of the extension side chamber R1 and the pressure of the compression side chamber R2 reaches the valve opening pressure, the extension side damping valve 13 is deflected by receiving the pressure of the extension side chamber R1 acting via the extension side port 2a to open the extension side port 2a, and allows communication between the extension side chamber R1 and the compression side chamber R2, thereby allowing the flow of the hydraulic oil from the extension side chamber R1 to the compression side chamber R2 and applying resistance to the flow of the hydraulic oil. On the other hand, when the pressure of the compression side chamber R2 is higher than the pressure of the extension side chamber R1, the extension side damping valve 13 is pressed by the pressure of the compression side chamber R2 acting from the back side to close the extension side port 2a, and allows communication between the extension side chamber R1 and the compression side chamber R2 only by the orifice 13a.

Subsequently, as illustrated in FIG. 1, the valve case 8 includes: a small-diameter portion 8a that has an annular shape and has a small diameter to be fitted to the lower end of the cylinder 1; a medium-diameter portion 8b that is located below the small-diameter portion 8a in FIG. 1, has a larger outer diameter than the small-diameter portion 8a, and is fitted to the lower end of the intermediate tube 7; an annular skirt 8c that is located below the medium-diameter portion 8b and has a larger outer diameter than the medium-diameter portion 8b; a notch 8d that is provided in the skirt 8c and allows communication between the inside and the outside of the skirt 8c; and a damping port 8e and a suction port 8f that communicate from a compression side chamber end which is an upper end in FIG. 1 facing the compression side chamber R2 to a counter-compression side chamber end facing the inside of the skirt 8c.

The valve case 8 is fixed to the outer tube 4 by being sandwiched between the outer tube 4 and the cylinder 1 with the small-diameter portion 8a fitted to the lower end of the cylinder 1 in FIG. 1, the medium-diameter portion 8b fitted to the lower end of the intermediate tube 7 in FIG. 1, and the lower end of the skirt 8c abutting on the bottom portion of the outer tube 4. The inside of the skirt 8c communicates with the liquid storage chamber R3 via the notch 8d, and communicates with the compression side chamber R2 through the damping port 8e and the suction port 8f. Therefore, the compression side chamber R2 and the liquid storage chamber R3 communicate with each other by the notch 8d, the inside of the skirt 8c, the damping port 8e, and the suction port 8f.

An extension side check valve 14 formed by stacking a plurality of annular plates is provided on the compression side chamber side, which is the upper side of the valve case 8 in FIG. 1. In the extension side check valve 14, an inner periphery thereof is fixed to an outer periphery of a center rod 15 inserted into an inner periphery of the valve case 8, and deflection on the outer peripheral side is allowed. When the pressure of the liquid storage chamber R3 becomes higher than the pressure of the compression side chamber R2, the extension side check valve 14 is deflected by receiving the pressure of the liquid storage chamber R3 acting via the suction port 8f to open the suction port 8f, thereby allowing the flow of the hydraulic oil from the liquid storage chamber R3 toward the compression side chamber R2. On the other hand, when the pressure of the compression side chamber R2 is higher than the pressure of the liquid storage chamber R3, the extension side check valve 14 is pressed by the pressure of the compression side chamber R2 acting from the back side to close the suction port 8f, thereby blocking communication between the compression side chamber R2 and the liquid storage chamber R3. The extension side check valve 14 may apply resistance to the flow of the hydraulic oil passing in a state where the suction port 8f is opened to such an extent that the pressure in the cylinder 1 does not become negative.

On the other hand, a compression side damping valve 16 formed by stacking a plurality of annular plates is provided on the counter-compression side chamber side, which is the lower side of the valve case 8 in FIG. 1. In the compression side damping valve 16, an inner periphery thereof is fixed to the outer periphery of the center rod 15, deflection on the outer peripheral side is allowed, and the initial deflection is applied. An orifice 16a formed by a notch is provided on the outer periphery of the annular plate of the compression side damping valve 16 that is separated from and seated on the valve case 8. The compression side damping valve 16 maintains the state of being seated on the valve case 8 until a difference between the pressure of the compression side chamber R2 and the pressure of the liquid storage chamber R3 reaches a valve opening pressure set by the initial deflection even when the pressure of the compression side chamber R2 becomes higher than the pressure of the liquid storage chamber R3. Therefore, in this state, the hydraulic oil moves from the compression side chamber R2 to the liquid storage chamber R3 only via the orifice 16a, and the orifice 16a applies resistance to the flow of the hydraulic oil. In addition, when the pressure of the compression side chamber R2 becomes higher than the pressure of the liquid storage chamber R3 and the difference between the pressure of the compression side chamber R2 and the pressure of the liquid storage chamber R3 reaches a valve opening pressure, the compression side damping valve 16 is deflected by receiving the pressure of the compression side chamber R2 acting via the damping port 8e to open the damping port 8e and allows communication between the compression side chamber R2 and the liquid storage chamber R3, thereby allowing the flow of the hydraulic oil from the compression side chamber R2 toward the liquid storage chamber R3 and applying resistance to the flow of the hydraulic oil. On the other hand, when the pressure of the liquid storage chamber R3 is higher than the pressure of the compression side chamber R2, the compression side damping valve 16 is pressed by the pressure of the liquid storage chamber R3 acting from the back side to close the damping port 8e, and allows communication between the compression side chamber R2 and the liquid storage chamber R3 only by the orifice 16a.

As described above, the intermediate tube 7 covers the outer periphery of the cylinder 1 and is sandwiched between the rod guide 9 and the valve case 8, and forms the annular damping passage P between the intermediate tube 7 and the cylinder 1. The damping passage P communicates with the extension side chamber R1 through a hole 1a provided in the cylinder 1, and communicates with the liquid storage chamber R3 through the variable damping valve V. The intermediate tube 7 partitions the cylinder 1 and the outer tube 4, and forms the annular liquid storage chamber R3 between the intermediate tube 7 and the outer tube 4.

The intermediate tube 7 includes a hole 7a on the lower side and a socket 7b that surrounds the hole 7a on the outer periphery and protrudes in the radial direction. A valve housing 17 including the variable damping valve V therein is fitted in the socket 7b. The socket 7b and the valve housing 17 are sealed by a seal member (not illustrated), and the damping passage P and the liquid storage chamber R3 are prevented from communicating with each other via the valve housing 17 and the socket 7b. Although the hole 1a provided in the cylinder 1 is used when the damping passage P in the intermediate tube 7 communicates with the extension side chamber R1, instead of the hole 1a, a passage that allows communication between the extension side chamber R1 and the annular gap between the cylinder 1 and the intermediate tube 7 may be provided in the rod guide 9 to allow communication between the damping passage P and the extension side chamber R1.

The outer tube 4 includes a hole 4a provided at a position radially facing the hole 7a and the socket 7b of the intermediate tube 7, and a valve attachment tube 4b surrounding the hole 4a on the outer periphery and protruding in the radial direction. The valve housing 17 is fitted in the valve attachment tube 4b, and an opening edge of the valve attachment tube 4b is closed by a cap 19 having a bottomed tubular shape and screwed to the outer periphery of the valve attachment tube 4b. A seal member (not illustrated) is provided between the valve housing 17 and the valve attachment tube 4b to prevent the hydraulic oil in the liquid storage chamber R3 from leaking out of the outer tube 4 from between the valve housing 17 and the valve attachment tube 4b.

In the valve housing 17, a distal end is inserted into the socket 7b of the intermediate tube 7 and a rear end is inserted into the valve attachment tube 4b of the outer tube 4, with the distal end facing the damping passage P and a side portion facing the liquid storage chamber R3. The valve housing 17 includes a flow path 18 that opens from the distal end, communicates laterally, and allows communication between the damping passage P in the intermediate tube 7 and the liquid storage chamber R3 in the outer tube 4, and the variable damping valve V installed in the middle of the flow path 18. The flow path 18 in the valve housing 17 allows communication between the annular gap formed between the intermediate tube 7 and the outer tube 4 and communicating with the extension side chamber R1 and the liquid storage chamber R3, and forms the damping passage P together with the annular gap. Therefore, the variable damping valve V is provided in the middle of the damping passage P.

The variable damping valve V allows only the flow of the hydraulic oil from the extension side chamber R1 to the liquid storage chamber R3 through the damping passage P and applies resistance to the flow of the hydraulic oil passing through the damping passage P. More specifically, the variable damping valve V, which is a solenoid valve provided with a solenoid, is configured to apply resistance to the hydraulic oil flowing through the damping passage P from the extension side chamber R1 to the liquid storage chamber R3 and to adjust a valve opening pressure by means of a current applied to the solenoid. The variable damping valve V configured as described above functions as a pressure control valve that adjusts a valve opening pressure in accordance with the amount of electricity to the solenoid and can adjust a damping force generated by the shock absorber. In addition to the damping valve that makes the damping force variable by adjusting the valve opening pressure, for the variable damping valve V, a damping valve having any configuration can be used as long as it can adjust a damping force.

Subsequently, the tank 6 is provided outside the outer tube 4 and includes a tubular container 6a and a free piston 6b that is movably inserted into the container 6a and partitions an inside of the container 6a into a liquid chamber L filled with hydraulic oil and a gas chamber G filled with gas. Gas is sealed in the gas chamber G in a compressed state, and the inside of the liquid chamber L in the tank 6 is pressurized by the pressure of the gas chamber G. The liquid chamber L of the tank 6 and the liquid storage chamber R3 in the outer tube 4 communicate with each other through a pipe 5, and the hydraulic oil can move back and forth between the liquid chamber L and the liquid storage chamber R3.

The pipe 5 is formed of a flexible hose, and has one end connected to a lower end of the container 6a and the other end connected to an outer periphery of the outer tube 4 at a position not interfering with the valve housing 17. The pipe 5 may be formed of a material having no flexibility such as a steel pipe in addition to the flexible hose. Note that the liquid chamber L and the gas chamber G in the tank 6 are partitioned by the free piston 6b, but may be partitioned by a partitioning member such as a bladder, a diaphragm, or a bellows that can partition the liquid chamber L and the gas chamber G and change the distribution of a volume of the liquid chamber L and a volume of the gas chamber G in the container 6a. In addition, for example, a partitioning member that partitions the liquid chamber L and the gas chamber G may be eliminated as long as the gas can be prevented from moving from the container 6a in the tank 6 to the liquid storage chamber R3 by disposing a connection portion to the pipe 5 of the container 6a on the lower side. Furthermore, a structure in which one end of the container 6a is opened to the atmosphere and a spring for biasing the free piston 6b in the direction of pressurizing the liquid chamber L is accommodated in the container 6a may be adopted. In this case, the gas chamber G in which gas is sealed may not be provided in the container 6a.

The other end of the pipe 5 only needs to be connected to a location that is separated from the valve housing 17 and does not interfere with the valve housing as long as it is a side portion of the outer tube 4, and thus may be connected to any portion in the entire length range in the axial direction of the outer tube 4. The other end of the pipe 5 may be connected to the rod guide 9, and the rod guide 9 may be provided with a passage for allowing communication between the inside of the pipe 5 and the liquid storage chamber R3.

Hereinafter, the operation of the shock absorber D configured as described above will be described. First, a case where the shock absorber D extends will be described. When the piston 2 moves upward in FIG. 1 with respect to the cylinder 1 and the shock absorber D is in an extension stroke, the extension side chamber R1 is compressed and the compression side chamber R2 is enlarged. When the piston speed, which is the moving speed of the piston 2 with respect to the cylinder 1, is low, the pressure of the extension side chamber R1 becomes higher than the pressure of the compression side chamber R2, but a differential pressure between the two chambers does not reach the valve opening pressure of the extension side damping valve 13. Therefore, since the extension side damping valve 13 maintains a valve closed state, the hydraulic oil moves from the extension side chamber R1 to the compression side chamber R2 through the orifice 13a.

Here, when the valve opening pressure of the variable damping valve V is made lower than the valve opening pressure of the extension side damping valve 13, the variable damping valve V opens at a piston speed lower than the piston speed at which the extension side damping valve 13 opens, so that the hydraulic oil moves from the extension side chamber R1 to the liquid storage chamber R3 through the damping passage P in addition to the orifice 13a. When the valve opening pressure of the variable damping valve V is made higher than the valve opening pressure of the extension side damping valve 13, the variable damping valve V remains closed, so that the hydraulic oil moves from the extension side chamber R1 to the compression side chamber R2 only through the orifice 13a.

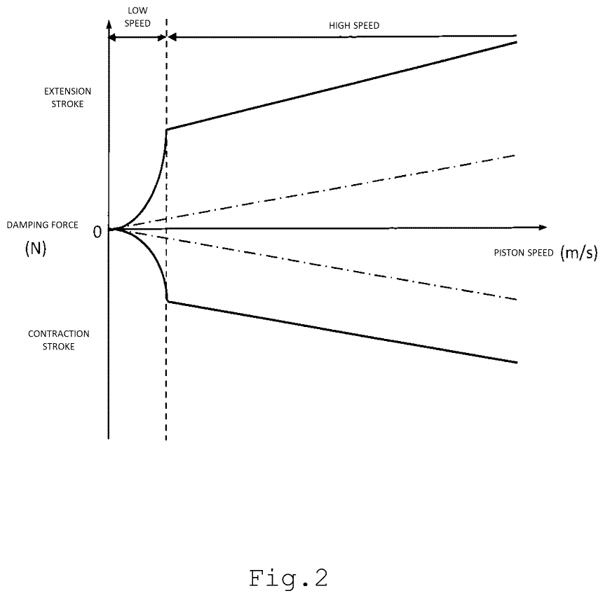

When the piston speed is within a low-speed range during an extension stroke, as illustrated in FIG. 2, the shock absorber D, in response to the regulation of the variable damping valve V, can adjust the damping force within a range from a damping force (dashed line in FIG. 2) at which the valve opening pressure of the variable damping valve V is set to a minimum value to a damping force (solid line in FIG. 2) generated only by the orifice 13a.

Since the piston rod 3 retracts from the inside of the cylinder 1 during the extension stroke of the shock absorber D, an amount of hydraulic oil equivalent to the volume of the piston rod 3 retracting from the cylinder 1 is insufficient inside the cylinder 1. The extension side check valve 14 is opened to supply the hydraulic oil equivalent to the volume that is insufficient inside the cylinder 1 from the liquid chamber L of the tank 6 into the cylinder 1 via the liquid storage chamber R3 and the pipe 5. In the tank 6, since the hydraulic oil is discharged from the liquid chamber L, the free piston 6b moves in the container 6a, reducing the volume of the liquid chamber L while enlarging the volume of the gas chamber G. As described above, in the extension stroke of the shock absorber D, the hydraulic oil is supplied from the tank 6 into the cylinder 1, to compensate for the volume of the piston rod 3 retracted from the inside of the cylinder 1.

When the piston speed increases during the extension stroke, the differential pressure between the extension side chamber R1 and the compression side chamber R2 increases. The pressure inside the extension side chamber R1 can be controlled by adjusting the valve opening pressure of the variable damping valve V until the differential pressure between the extension side chamber R1 and the compression side chamber R2 reaches the valve opening pressure of the extension side damping valve 13. When the differential pressure between the extension side chamber R1 and the compression side chamber R2 reaches the valve opening pressure of the extension side damping valve 13, the extension side damping valve 13 is opened to open the extension side port 2a. Then, the hydraulic oil passes through the annular gap appearing between the extension side damping valve 13 and the piston 2 and moves from the extension side chamber R1 to the compression side chamber R2.

When the piston speed is within a high-speed range during the extension stroke, as illustrated in FIG. 2, the shock absorber D, in response to the regulation of the variable damping valve V, can adjust the damping force within a range from the damping force (dashed line in FIG. 2) at which the valve opening pressure of the variable damping valve V is set to the minimum value to the damping force (solid line in FIG. 2) generated by the extension side damping valve 13.

In addition, when the variable damping valve V is opened during the extension stroke, the hydraulic oil passes through the damping passage P and the variable damping valve V and flows out from the extension side chamber R1 to the liquid storage chamber R3, but the inside of the liquid storage chamber R3 is filled only with the hydraulic oil, and the hydraulic oil having a high flow rate that has passed through the variable damping valve V does not come into contact with the gas at all in the liquid storage chamber R3, so that it is possible to prevent the entrainment of the gas. In the shock absorber D of the present embodiment, the inside of the container 6a of the tank 6 is partitioned into the liquid chamber L and the gas chamber G by the free piston 6b. Therefore, since the hydraulic oil does not come into direct contact with the gas even in the tank 6, there is no problem even when the hydraulic oil flows in the tank 6. However, even when the free piston 6b and other partitioning members that separate the gas and the hydraulic oil are eliminated, and even when the hydraulic oil that has passed through the variable damping valve V flows toward the liquid chamber L in the tank 6, the flow becomes gentle while passing through the pipe 5, so that it is possible to prevent the hydraulic oil from entraining the gas in the tank 6.

Next, a case where the shock absorber D contracts will be described. When the piston 2 moves downward in FIG. 1 with respect to the cylinder 1 and the shock absorber D is in a contraction stroke, the compression side chamber R2 is compressed and the extension side chamber R1 is enlarged. When the piston speed is low, the pressure of the compression side chamber R2 becomes higher than the pressure of the extension side chamber R1. Then, the compression side check valve 12 is opened, and the hydraulic oil moves from the compression side chamber R2 to the extension side chamber R1.

In addition, since the piston rod 3 is inserted into the cylinder 1 during the contraction stroke of the shock absorber D, the amount of hydraulic oil equivalent to the volume of the piston rod 3 inserted into the cylinder 1 becomes excessive inside the cylinder 1. When the piston speed is low, the differential pressure between the compression side chamber R2 and the liquid storage chamber R3 is small, and thus the compression side damping valve 16 maintains the valve closed state, so that the hydraulic oil moves from the compression side chamber R2 to the liquid storage chamber R3 through the orifice 16a.

Here, when the valve opening pressure of the variable damping valve V is made lower than the valve opening pressure of the compression side damping valve 16, the variable damping valve V opens at a piston speed lower than the piston speed at which the compression side damping valve 16 opens, so that the hydraulic oil moves from the inside of the cylinder 1 to the liquid storage chamber R3 through the damping passage P in addition to the orifice 16a. When the valve opening pressure of the variable damping valve V is made higher than the valve opening pressure of the compression side damping valve 16, the variable damping valve V remains closed, so that the hydraulic oil moves from the compression side chamber R2 to the liquid storage chamber R3 only through the orifice 16a.

When the piston speed is within the low-speed range during the contraction stroke, as illustrated in FIG. 2, the shock absorber D, in response to the regulation of the variable damping valve V, can adjust the damping force within a range from the damping force (dashed line in FIG. 2) at which the valve opening pressure of the variable damping valve V is set to the minimum value to the damping force (solid line in FIG. 2) generated only by the orifice 16a.

When the piston speed increases during the contraction stroke, the differential pressure between the compression side chamber R2 and the liquid storage chamber R3 increases. When the differential pressure between the compression side chamber R2 and the liquid storage chamber R3 reaches the valve opening pressure of the compression side damping valve 16, the compression side damping valve 16 opens the damping port 8e. Until the differential pressure between the compression side chamber R2 and the liquid storage chamber R3 reaches the valve opening pressure of the compression side damping valve 16, the pressure in the cylinder 1 can be controlled by adjusting the valve opening pressure of the variable damping valve V.

When the piston speed is within the high-speed range during the contraction stroke, as illustrated in FIG. 2, the shock absorber D, in response to the regulation of the variable damping valve V, can adjust the damping force within a range from the damping force (dashed line in FIG. 2) at which the valve opening pressure of the variable damping valve V is set to the minimum value to the damping force (solid line in FIG. 2) generated by the compression side damping valve 16.

In addition, when the variable damping valve V is opened during the contraction stroke, the hydraulic oil passes through the damping passage P and the variable damping valve V and flows out from the extension side chamber R1 to the liquid storage chamber R3, but the inside of the liquid storage chamber R3 is filled only with the hydraulic oil, and the hydraulic oil having a high flow rate that has passed through the variable damping valve V does not come into contact with the gas at all in the liquid storage chamber R3, so that it is possible to prevent the entrainment of the gas. In the shock absorber D of the present embodiment, the inside of the container 6a of the tank 6 is partitioned into the liquid chamber L and the gas chamber G by the free piston 6b. Therefore, since the hydraulic oil does not come into direct contact with the gas even in the tank 6, there is no problem even when the hydraulic oil flows in the tank 6. However, even when the free piston 6b and other partitioning members that separate the gas and the hydraulic oil are eliminated, even when the hydraulic oil that has passed through the variable damping valve V flows toward the liquid chamber L in the tank 6, the flow becomes gentle while passing through the pipe 5, so that it is possible to prevent the hydraulic oil from entraining the gas in the tank 6.

As can be understood from the above description, the shock absorber D basically behaves as a uniflow-type shock absorber in which hydraulic oil flows from the inside of the cylinder 1 to the liquid storage chamber R3 through the variable damping valve V, regardless of whether the shock absorber D extends or shortens. When the pressure in the extension side chamber R1 becomes excessive, the extension side damping valve 13 functions as a relief valve to move the hydraulic oil from the extension side chamber R1 to the compression side chamber R2, and when the pressure in the compression side chamber R2 becomes excessive, the compression side damping valve 16 functions as a relief valve to move the hydraulic oil from the compression side chamber R2 to the liquid storage chamber R3.

As described above, the shock absorber D includes the cylinder 1; the piston 2 that is movably inserted into the cylinder 1 and partitions the inside of the cylinder 1 into the extension side chamber R1 and the compression side chamber R2 filled with hydraulic oil (liquid); the piston rod 3 that is inserted into the cylinder 1 and connected to the piston 2; the outer tube 4 that is disposed on the outer peripheral side of the cylinder 1 and forms a liquid storage chamber R3 filled only with hydraulic oil (liquid) inside; the damping passage P that allows communication between the extension side chamber R1 and the liquid storage chamber R3; the variable damping valve V that is provided in the damping passage P and capable of adjusting resistance applied to a flow of hydraulic oil (liquid) from the extension side chamber R1 toward the liquid storage chamber R3; and the tank 6 that is disposed outside the outer tube 4 and communicates with the liquid storage chamber R3 through the pipe 5 to store hydraulic oil (liquid).

In the shock absorber D configured as described above, since the tank 6 is provided outside the outer tube 4, the inside of the liquid storage chamber R3 can be filled only with the hydraulic oil (liquid), and even when the hydraulic oil (liquid) flows into the liquid storage chamber R3 through the variable damping valve V during the extension/contraction operation, it is possible to prevent the hydraulic oil (liquid) from entraining the gas in the liquid storage chamber R3. Even when the inside of the tank 6 is not partitioned into the gas and the liquid by the partitioning member, since the liquid storage chamber R3 communicates with the tank 6 through the pipe 5, the flow rate of the hydraulic oil (liquid) is reduced, so that it is also possible to prevent the gas from being entrained into the hydraulic oil (liquid) in the tank 6.

Therefore, according to the shock absorber D of the present embodiment, since there is no concern of entrainment of the gas in the liquid storage chamber R3, the entire length of the outer tube 4 can be shortened. Therefore, not only the basic length of the shock absorber D is shortened and the mountability on the installation target is not impaired, but also the entrainment of the gas into the hydraulic oil (liquid) can be prevented, so that the gas can be prevented from being mixed into the cylinder 1 and the intended damping force can be exerted.

In the shock absorber D of the present embodiment, since only the hydraulic oil (liquid) is filled in the liquid storage chamber R3 in the outer tube 4, the shock absorber main body including the cylinder 1, the piston 2, the piston rod 3, and the outer tube 4 can be used in an inverted arrangement with the cylinder 1 facing upward and the piston rod 3 facing downward or in a horizontal arrangement, and the shock absorber main body can be installed according to the specification of the installation location of the shock absorber D, so that the mountability of the shock absorber D is improved also in this respect.

In the shock absorber D of the present embodiment, since the inside of the liquid storage chamber R3 is filled only with the hydraulic oil (liquid), it is possible to prevent the gas from being entrained into the hydraulic oil (liquid) regardless of where the variable damping valve V is installed in the outer tube 4. Therefore, according to the shock absorber D of the present embodiment, since the installation position of the variable damping valve V with respect to the outer tube 4 can be freely set, a degree of freedom in designing the shock absorber D is improved. The variable damping valve V may be installed in the rod guide 9 or the valve case 8 in addition to the outer tube 4.

Furthermore, in the shock absorber D of the present embodiment, the outer tube 4 covers the cylinder 1 over the entire length in the axial direction. According to the shock absorber D configured as described above, since the outer tube 4 covers the entire length of the cylinder 1, the installation position of the variable damping valve V with respect to the outer tube 4 can be set to any position within the range of the entire length of the outer tube 4 in the axial direction, and thus a degree of freedom in designing the installation position of the variable damping valve V is improved.

In the shock absorber D of the present embodiment, the intermediate tube 7 disposed between the cylinder 1 and the outer tube 4 and forming the damping passage P between the intermediate tube 7 and the cylinder 1 is provided, and the liquid storage chamber R3 is formed between the intermediate tube 7 and the outer tube 4. According to the shock absorber D configured as described above, since the damping passage P and the liquid storage chamber R3 can be easily formed with a simple structure by installing the intermediate tube 7 between the cylinder 1 and the outer tube 4, manufacturing cost can be reduced, and assembly work is facilitated. In forming the damping passage P, the intermediate tube 7 may be eliminated, a pipe having one end attached to the rod guide 9 and accommodated between the cylinder 1 and the outer tube 4 may be provided, the inside of the pipe may be communicated with the extension side chamber R1 by the passage provided in the rod guide 9, and the other end of the pipe may be communicated with the liquid storage chamber R3 formed by the annular gap between the cylinder 1 and the outer tube 4 to form the damping passage P by the pipe. The variable damping valve V may be provided in the middle of the pipe.

Furthermore, the intermediate tube 7 may be eliminated, the extension side chamber R1 may communicate with the liquid storage chamber R3 formed by the annular gap between the cylinder 1 and the outer tube 4 by the passage provided in the rod guide 9, and the variable damping valve V may be installed in the rod guide 9. In this case, since the intermediate tube 7 and the pipe are unnecessary, the number of parts of the shock absorber D can be reduced.

Further, in the shock absorber D of the present embodiment, the outer tube 4 covers the cylinder 1 and the intermediate tube 7 over the entire length in the axial direction, but the axial length of the outer tube 4 may be shorter than that of the cylinder 1 and the intermediate tube 7 on the condition that the liquid storage chamber R3 can be formed so that the hydraulic oil (liquid) can be prevented from entraining the gas in the outer tube 4, and the variable damping valve V is accommodated in the range of the entire length in the axial direction of the outer tube 4.

When the connection position of the pipe 5 to the outer tube 4 or the rod guide 9 is set to a position separated from the installation position of the variable damping valve V in the circumferential direction and the vertical direction, it is possible to prevent the hydraulic oil having a high flow rate, which has passed through the variable damping valve V and flowed into the liquid storage chamber R3 from the inside of the cylinder 1, from flowing into the tank 6, and it is possible to smoothly send the hydraulic oil insufficient inside the cylinder 1 from the inside of the tank 6 at the time of extension operation of the shock absorber D, and it is expected that a more stable damping force is exhibited.

In the above description, the compression side check valve 12 and the extension side damping valve 13 are provided in the piston 2, and the extension side check valve 14 and the compression side damping valve 16 are provided in the valve case 8. However, the shock absorber D may be a uniflow-type shock absorber in which the piston 2 includes only the compression side port 2b and the compression side check valve 12, the valve case 8 includes only the suction port 8f and the extension side check valve 14, and a damping force is generated only by the variable damping valve V.

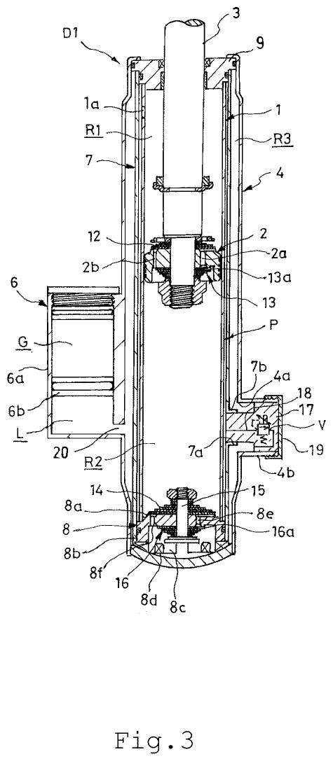

Furthermore, in the shock absorber D described above, the tank 6 and the liquid storage chamber R3 communicate with each other through the pipe 5. However, in a case where the container 6a forming the tank 6 is integrally formed in the outer tube 4 as in a shock absorber D1 in a modification of the embodiment shown in FIG. 3, the pipe 5 may be eliminated, and the liquid storage chamber R3 and the liquid chamber L of the tank 6 may communicate with each other through a hole 20 penetrating the outer tube 4 and the container 6a. In the shock absorber D1 configured as described above, since the tank 6 is provided outside the outer tube 4, the inside of the liquid storage chamber R3 can be filled only with the hydraulic oil (liquid), and even when the hydraulic oil (liquid) flows into the liquid storage chamber R3 through the variable damping valve V during the extension/contraction operation, it is possible to prevent the hydraulic oil (liquid) from entraining the gas in the liquid storage chamber R3. Even when the inside of the tank 6 is not partitioned into the gas and the liquid by the partitioning member, since the liquid storage chamber R3 communicates with the tank 6 through the hole 20, the flow rate of the hydraulic oil (liquid) is reduced, so that it is also possible to prevent the gas from being entrained into the hydraulic oil (liquid) in the tank 6. Therefore, according to the shock absorber D1 configured as described above, since there is no concern of entrainment of the gas in the liquid storage chamber R3, the entire length of the outer tube 4 can be shortened. Therefore, not only the basic length of the shock absorber D1 is shortened and the mountability on the installation target is not impaired, but also the entrainment of the gas into the hydraulic oil (liquid) can be prevented, so that the gas can be prevented from being mixed into the cylinder 1 and the intended damping force can be exerted.

Although a preferred embodiment of the present invention has been described above in detail, modifications, variations, and changes can be made without departing from the claims.

### REFERENCE SIGNS LIST

1 Cylinder
2 Piston
3 Piston rod
4 Outer tube
6 Tank
7 Intermediate tube
D Shock absorber
P Damping passage
R1 Extension side chamber
R2 Compression side chamber
R3 Liquid storage chamber
V Variable damping valve

1. A shock absorber comprising:
a cylinder;
a piston that is movably inserted into the cylinder and partitions an inside of the cylinder into an extension side chamber and a compression side chamber filled with a liquid;
a piston rod that is inserted into the cylinder and connected to the piston;
an outer tube that is disposed on an outer peripheral side of the cylinder and forms a liquid storage chamber filled only with a liquid inside;
a damping passage that allows communication between the extension side chamber and the liquid storage chamber;
a variable damping valve that is provided in the damping passage and capable of adjusting resistance applied to a flow of a liquid from the extension side chamber to the liquid storage chamber; and
a tank that is disposed outside the outer tube and communicates with the liquid storage chamber to store a liquid.

2. The shock absorber according to claim 1, wherein
the outer tube covers the cylinder over an entire length in an axial direction.

3. The shock absorber according to claim 2, comprising:
an intermediate tube that is disposed between the cylinder and the outer tube and forms the damping passage between the intermediate tube and the cylinder, wherein
the liquid storage chamber is formed between the intermediate tube and the outer tube.
